(19) United States
(12) Patent Application Publication
(10) Pub. No.: US 2026/0161943 A1
(43) Pub. Date: Jun. 11, 2026

(54) ENHANCING OUTPUT PRECISION FOR PERFORMING OPERATIONS OF MACHINE LEARNING MODELS

(71) Applicant: BLACK SESAME TECHNOLOGIES INC., San Jose, CA (US)

(72) Inventors: Guanhua Ding, San Jose, CA (US); Zihao Zhao, San Jose, CA (US); Xiaodong Wang, San Jose, CA (US)

(21) Appl. No.: 18/970,669

(22) Filed: Dec. 5, 2024

(51) Int. Cl. G06N 3/082

(52) U.S. Cl. CPC G06N 3/082

(57) ABSTRACT

Methods, systems, and apparatuses, including computer programs encoded on computer storage media, for performing operations represented by a neural network, The operations comprise: processing a layer input to a network layer of a neural network and one or more nodal weights of the network layer using one or more compute nodes, where at least one of the one or more compute nodes natively generates output having a first data size. The processing comprises processing at least a plurality of upper bits of the layer input to generate an intermediate output. The processing further comprises processing the intermediate output using a new network layer that immediately succeeds the network layer to generate a layer output. The layer output has a higher precision than an output directly generated by processing the layer input via the network layer using the one or more nodes.

### BACKGROUND

This specification relates to performing operations of machine learning models, particularly enhancing model output precision using one or more compute nodes that natively generate output with a lower precision.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with the current values of a respective set of parameters.

### SUMMARY

This specification describes techniques for generating model output from a machine learning model using one or more compute nodes that natively produce (or output) lower-precision outputs. The described techniques can extract outputs with higher precision using these compute nodes without modifying or redesigning the hardware architecture by leveraging intermediate results within these compute nodes before output. These intermediate results usually have a higher precision. For example, least one of the one or more compute nodes generates output stored in X bits, where X is at least one, although the corresponding intermediate computations (e.g., multiplications and add) are performed within these compute nodes at a higher precision, such as 2X.

The described techniques allow for generating outputs with higher precision (stored in the same or more bits) than the one or more compute nodes can natively do. The one or more compute nodes can, for example, include nodes on a Central Processing Unit (CPU), a Graph Processing Unit (GPU), or other suitable computation unit. The one or more compute nodes can include an accumulator or a multiplier-accumulator units (MAC) unit. The machine learning model can include a neural network with a plurality of neural network layers, each network layer having a plurality of nodes and corresponding nodal weights. The computations associated with the machine learning model or neural network can include convolution operations, matrix multiplication, or other suitable operations.

One aspect of the subject matter described in this specification can be embodied in a method that includes operations for performing operations of a neural network. More specifically, the method includes processing a layer input to a network layer of a neural network and one or more nodal weights of the network layer using one or more compute nodes. These compute nodes can only natively generate outputs having a first data size, which usually has limited accuracy.

The processing of the layer input and nodal weights first includes processing at least a plurality of upper bits of the layer input to generate an intermediate output. The intermediate output is accessible by external hardware or memory units. The intermediate output includes a first portion and a second portion, where the first portion includes a first set of upper-bit results generated from the plurality of upper bits of the layer input, and the second portion includes the layer input or a second set of upper-bit results. The first set of upper-bit results and the second set of upper-bit results can both have the first data size that is natively supported by the compute notes.

The processing further includes processing the intermediate output using a new network layer that immediately succeeds the network layer to generate a layer output. The new network layer is not originally included in the neural network. The new network layer includes the same nodal weights as the network layer and one or more additional nodal weights. The one or more additional nodal weights can form an identity tensor. Note that the layer output generally has a higher precision than that natively supported by one or more compute nodes and is thus stored in a second data size greater than the first data size. However, when the techniques described below are implemented, the layer output can still have a higher precision than those directly generated by processing the layer input via the network layer using the one or more nodes even if the layer output is stored and output in a format having the first data size.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

Particular embodiments of the subject matter described in this specification can be implemented to achieve one or more of the following advantages. The described techniques allow compute nodes that natively produce lower-precision output for a machine learning model to generate output with enhanced precision (using the same or more bits). Specifically, compute nodes that natively generate model output at a size of X bits only allow external hardware components (e.g., memory, processing units, other compute nodes) to access the output stored in X bits, even though the internal computations performed by the compute node use a higher precision (e.g., 2X bits). This loss of precision for downstream operations may ultimately affect model accuracy due to the hardware limitations of the compute nodes. The described techniques involve special operations performed by one or more compute nodes to generate model output with higher precision and/or more bits. These operations include modifying the parameters of the machine learning model and preserving lower-bit data obtained during internal computations by passing down the model input or intermediate output. For a neural network, these special operations typically involve modifying nodal weights of a targeted network layer, and the techniques preserve lower-bit information by passing down the layer input and/or the intermediate output generated by the modified network layer.

In addition, the described techniques can increase the efficiency of performing operations represented by a machine learning model and reduce the memory usage thereof by replacing particular operations (such as concatenation, copy, and combination of upper and lower bits, etc.,) with using a modified machine learning model. Taking the concatenation operation as an example, the described techniques can still generate an intermediate output for an input by combining two set of data using conventional concatenation techniques if the memory usage and corresponding overhead (e.g., idle time for data transfer of the two sets of data) are acceptable. That being said, the described techniques can still generate intermediate output by combining two sets of data using conventional concatenation techniques, provided the memory usage and corresponding overhead (e.g., idle time for data transfer between the two sets of data) are acceptable. That said, the described techniques can reduce or even eliminate idle time by generating the intermediate output directly from the modified machine learning model, without requiring data transfer between the compute node and the corresponding memory unit (e.g., Dynamic Random Access Memory (DRAM)). In the context of a neural network, the described techniques can modify one or more nodal weights of a targeted network layer, and the intermediate output may include the original output generated by the compute nodes, a portion of the layer input, and/or other outputs generated from the network layer.

The described techniques are adaptable to various precision requirements for performing computation operations represented by a machine learning model using the aforementioned compute nodes. Specifically, they include a global variable that can be set to different values to enable or disable the precision enhancement function for the compute nodes and the machine learning model. This allows users to easily switch the precision enhancement function on or off by adjusting the global variable accordingly. This way, the described techniques reduce the time and cost of upgrading the hardware, shortening the cycles for further research and development.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example precision enhancement system configured to process layer input to generate layer output.

FIG. 2 illustrates an example operation flow for generating a layer output of 2X bits from a layer input of X bits using the example precision enhancement system of FIG. 1.

FIG. 3 illustrates an example operation flow for generating a layer output of 2X bits from a layer input of 2X bits using the example precision enhancement system of FIG. 1.

FIG. 4 illustrates an example operation flow for generating a layer output of X bits from a layer input of 2X bits using the example precision enhancement system of FIG. 1.

FIG. 5 illustrates an example operation flow for generating an intermediate output using a modified network layer.

FIG. 6 illustrates an example operation flow for generating an augmented intermediate output using a copy convolution layer.

FIG. 7 is a flow diagram of an example process for processing a layer input to generate a layer output using the example precision enhancement system of FIG. 1.

Like reference numbers and designations in the various drawings indicate like elements.

### DETAILED DESCRIPTION

The described techniques relate to enhancing the numerical value precision of output generated by one or more compute nodes that perform operations represented by a machine learning model. These compute nodes natively store and output data with a precision lower than the enhanced precision, even though the internal computations performed by one or more compute nodes use values with a higher precision (e.g., the enhanced precision). By modifying portions of machine learning models, or the process of obtaining model output using these models, the described techniques can surpass the hardware precision limitations of the compute nodes without altering the hardware architecture.

The described techniques are critical for compute nodes that are used across different applications, where the native precision supported by the compute nodes satisfies some or even most of the applications, yet occasionally, a higher precision is preferred. This way, systems using the described techniques can improve the accuracy of machine learning models while simultaneously reducing the time and cost associated with hardware upgrades, thus enhancing the performance of machine learning models and shortening the cycles for further research and development using these compute nodes.

Furthermore, the described techniques are adaptive to different computational tasks with varying precision requirements. Specifically, a user can toggle a global variable between different values to enable or disable the precision enhancement function for these compute nodes without needing to replace or upgrade any of the compute nodes. The same set of compute nodes can accordingly be used for tasks with different precision requirements.

One practical application of the described techniques relates to the perception stage in autonomous driving. In autonomous driving, one critical perception function is understanding the positional information of objects in a scene. One method for computing positional information is to obtain the depth image or depth information for corresponding objects of interest in a scene. Typically, for accurate distance detection ranging from 0 to 200 meters, the precision needs to be within 0.5 meters. One approach to ensure high precision is to use compute nodes that support outputting data stored in larger data sizes, which might require upgrading the hardware or modifying the compute nodes at the hardware architecture level. Another approach would be to reassign corresponding computations from the compute nodes to one or more general processors with higher precision. However, this often results in suboptimal performance of the chip as a whole. The described techniques enable higher precision using the same compute nodes without compromising the overall performance of the corresponding hardware unit. To achieve higher precision, the described techniques can combine different bits or portions of output generated from a machine learning model (e.g., different portions of the output of a current network layer of a neural network), pass and copy portions of the data without introducing additional data transfer overhead, and shift digits of the stored data without overflow.

Note that the term “precision,” as used throughout the specification, generally refers to a data size used for storing the corresponding data. Typically, higher precision involves using larger data sizes to store corresponding numerical values. As an example, the one or more compute nodes described here can natively generate output stored in 8 bits with a first precision, while internal computations performed within the one or more compute nodes use values stored in 16 bits or 24 bits, which has a second precision higher than the first precision. However, in the following description, the term “precision” can also represent mathematical or numerical accuracy. More specifically, a stored numerical value can have a higher precision than another even if both values are stored using the same number of bits. This is achieved by accounting for the contribution of lower bits of an input to the upper-bit information of an output. Accordingly, for simplicity, the description below adopts the term “precision” to represent either definition as discussed above by default, unless otherwise indicated.

Note that the terms “upper-bit” (or “upper bits”) and “lower-bit” (or “lower bits”), as used throughout the specifically, generally represent binary values that are stored in the first (or the left-most) couple of bits in a data structure, and the last (or the right-most) couple of bits in the data structure, respectively. For example, for 16-bit data, the upper 8 bits refer to the highest 8 bits of binary values stored in the 16-bit data and the lower 8 bits refer to the lowest 8 bits of binary values stored in the 16-bit data.

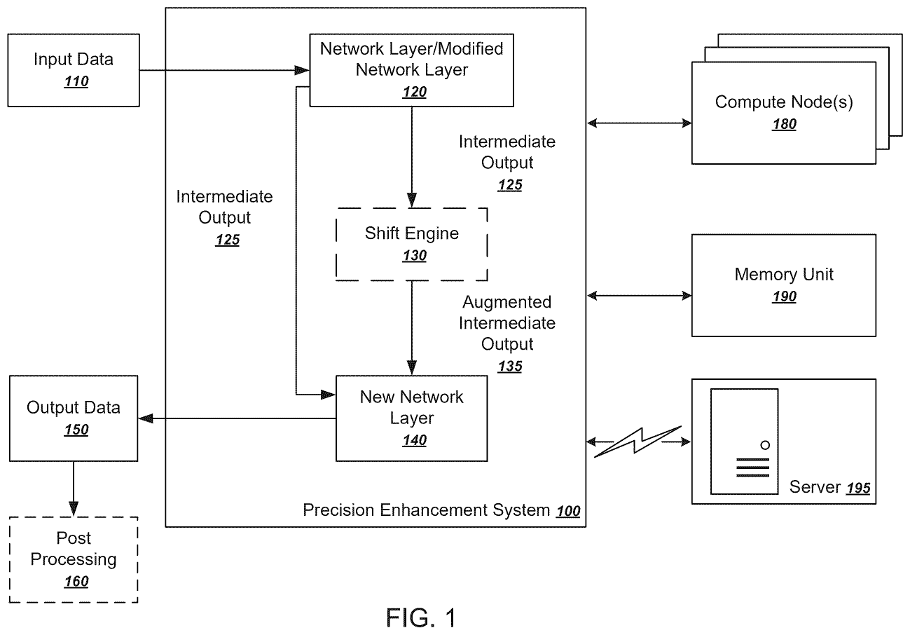

FIG. 1 illustrates an example precision enhancement system 100 configured to process input data 110 to generate output data 150. In general, the precision enhancement system 100 can be implemented on one or more computers or processors at one or more locations. The one or more computers or processors can be coupled with one another wirelessly or by wires. The one or more computers or processors can include one or more CPUs, GPUs, TPUs, or other suitable types of processors. For simplicity, the precision enhancement system 100 is also referred to as system 100 in the following description.

As shown in FIG. 1, system 100 is configured to process input data 110 to generate output data 150. System 100 generally couples with one or more compute nodes 180, each being configured to perform a portion of computation operations represented by a machine learning model assigned to the compute code. The one or more compute nodes 180 natively store and generate output in a first data size. For example, the first data size can be 8 or 16 bits. Note that the one or more compute nodes 180 are configured to perform internal computations with data of a larger size, e.g., 16 bits or 24 bits. However, when each compute node completes the assigned computation, it natively generates output data stored in the first data size, which has a lower precision than those used in the internal computations. Components external to the one or more compute nodes can only access data with the first data size from the one or more compute nodes.

The precision enhancement system 100 is configured to obtain the output data 150 with a higher precision (e.g., stored in a data format using more numbers of bits) than that natively supported by the one or more compute nodes. For example, for situations where the first data size is 8-bit, the output data 150 can have a size of 16 bits or 24 bits. Note that the data size of the input data 110 can be 8 bits, 16 bits, 24 bits, or other suitable numbers of bits, since the techniques described herein account mainly for the precision loss due to the hardware limit of the one or more compute nodes assigned to perform operations of a machine learning model.

Thus, as a more general example, the first data size can natively generate output of X bits, where X is greater than or equal to one. For example, X can be 8, 16, 24, 32, or other suitable positive integers. As an example, where the first data size is X-bit, the input data 110 can have a size of X bits, and the corresponding output data 150 can have a size of 2X bits. As another example, the input data 110 can have a size of 2X bits, and the corresponding output data 150 can have a size of 2X bits. For situations where the X equals to 8, the input data 110 can have a size of 8 bits and the corresponding output data 150 can have a size of 16 bits, or the input data 110 can have a size of 16 bits and the corresponding output data 150 can have a size of 16 bits.

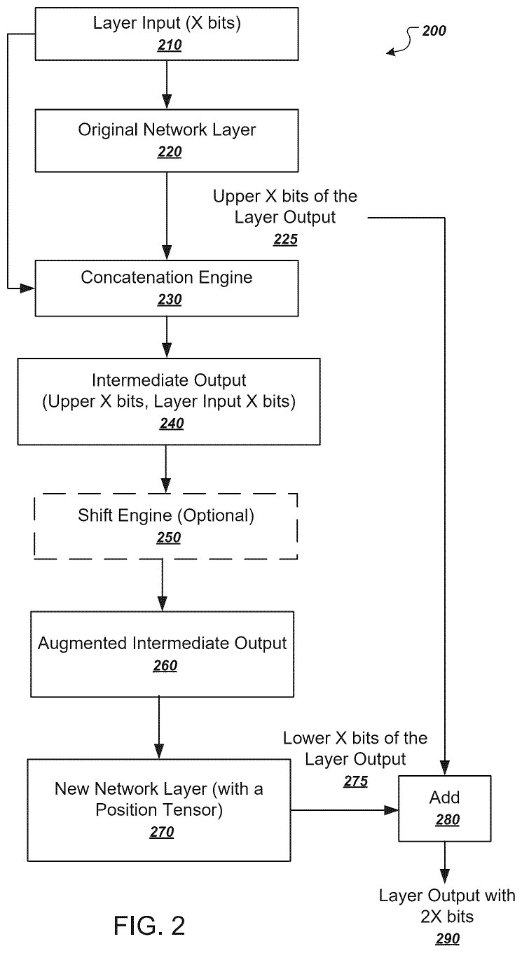

In some cases, the output data 150 might have the same size as the first data size (X bits) that is natively supported by the one or more compute nodes. However, the output data 150 still has a higher precision (even using the same data size) since system 100 accounts for upper-bit information generated by lower bits of the input data 110. According to the above-noted examples, the input data 110 can have a size of 2X bits and the corresponding output data 150 can have a size of X bits. Although the output data 150 has the same size of the first data size (i.e., X bits), the output data 150 still has a higher precision since the system 100 combines (i) the original X-bit output that the one or more compute nodes can natively generate with (ii) additional upper-bit information generate by lower bits of input data 110. More details of how the output data 150 are generated with various data sizes using the one or more compute nodes are described below in connection with FIGS. 2, 3, and 4.

For situations where the machine learning model is a neural network, the input data 110 can be a layer input to a current network layer of a neural network, and the output data 150 can be a layer output from the current network layer as if it is directly calculated using the one or more compute nodes but with higher precision (or stored using more bits). The input data 110 and output data 150 can be stored in various data types, such as the integer type or floating-point type. For example, the input data 110 can be stored in INT8 or UINT8, INT16 or UINT16, or other suitable data types. The output data 150 can be stored in INT8 or UINT8, INT16 or UINT16, or other suitable data types. Note that for situations where the input data 110 and output data 150 are stored using integer types, the input data 110 and output data 150 can still represent non-integer numerical values using information representing the decimal point locations.

The computation result of the input data 110 is further provided as input to one or more nodal activation functions of the current nodes in the current layer. The nodal activation functions generally perform nonlinear transformation over the computation result before the computation result is provided as output from the current nodes to corresponding nodes in the immediately succeeding layer of the neural network.

In some implementations, the input data 110 can include nodal inputs and corresponding nodal weights of the current layer. The quantization system 100 can include a multiplication unit configured to process the nodal input and the nodal weights by multiplying them (and optionally summing them) to generate the computation result. For a particular hardware, the nodal output data and the nodal weights can be stored and received by the multiplication unit/or the quantization system 100 in a first size with a first precision (e.g., INT 8 with 8 bits), and the computation result can be stored in a second size with a second precision (e.g., INT16 with 16 bits or INT24 with 24 bits). For simplicity and ease of illustration, the input data 110 described below, by default, refers to a computation result based on nodal weights and nodal inputs for the current layer.

Output data 150 generally includes nodal output from the nodal activation functions of corresponding one or more nodes in the current layer. The output from the nodal activation functions is also referred to as the nodal output from the corresponding one or more nodes of the current layer. The output data 150 is then provided as input for one or more nodes in the succeeding layer of the neural network.

For a particular hardware or computation unit, the output data 150 is stored by data types having the same level of precision as the input data 110. For example, for situations where the quantization system 100 has a multiplication unit, the input data include nodal weights and corresponding nodal inputs with a data size of 8 bits (e.g., INT8 or UINT8), and the output data 150 accordingly has the same size of 8 bits (e.g., INT8 or UINT8). However, in some cases where the input data include computations results generated by the nodal inputs and nodal weights for the current layer, the input data can be stored in a data type or formatting with a greater size with a higher precision (e.g., INT16 or INT24), and the output data 150 can be stored in a data type or formatting with a lower precision (e.g., INT8 or UINT8). Note that output data 150 can be stored in an integer type, a floating type, or other suitable types with a particular size according to different computation requirements or hardware designs.

Referring back to the one or more compute nodes 180, it is noted that the one or more compute nodes 180 described in the following description generally refer to one or more accumulators. In some implementations, the one or more compute nodes 180 include one or more multiplier-accumulator (MAC) units. The one or more MAC units can further be specially arranged to form an array of MAC units, e.g., a two-dimensional array of MAC units or a three-dimensional array of MAC units. The one or more compute nodes can be arranged on a graphic processing unit (GPU). Alternatively, one or more compute nodes can be arranged on a central processing unit (CPU) or other suitable units.

Each compute node is configured to perform at least a portion of the computation operations of the machine learning model (or the network layer of the neural network). The operations can include one or more multiplication, one or more add operations, linear operations, and/or non-linear operations. For situations where the machine learning model is a neural network, the operations can include convolution operations for a network layer, and/or nodal activation operations of the network layer. For simplicity, the following techniques are described with respect to a neural network, but one should appreciate that the described techniques can be applied to various machine learning models in addition to neural networks.

System 100 first receives the input data 110 and causes the compute node 180 to process the input data 110 via a network layer 120 of a neural network. More specifically, each compute node is assigned to process a portion of input data 110 using a portion of corresponding nodal weights of the network layer to generate nodal activations. The compute node then processes the corresponding nodal activations by the nodal activation function to generate a respective partial nodal output. The compute nodes 180 can either accumulate the respective partial nodal outputs to generate a layer output for the current network layer or transfer the respective partial nodal outputs to an accumulation engine to generate the layer output. As described above, any computation results generated by the compute nodes 180 that are accessible by external components (e.g., external accumulators, nodes, or memory) are stored in the first data size (e.g., X bits), even though the internal computations are generally performed using data stored with more number of bits (e.g., 2X bits or 4X bits). System 100 is configured to preserve the higher precision for internal computations performed in the compute nodes 180 before any result data are stored in the first data size.

In some implementations, the network layer 120 is the last convolution layer in a convolutional neural network. The next layer that immediately succeeds the last convolution layer 120 can be a non-convolution layer, e.g., a softmax layer, a fully connected layer, or other suitable layers. Alternatively, the output of the last convolution layer 120 is transferred to a different node or compute unit for post-processing. The operations associated with the next layer or in the post-processing can be performed by a different set of compute nodes (other than the compute nodes 180) or units, which demand data with higher precision and/or can generate output with precision higher than that of the compute nodes 180 (e.g., the first data size). The post-processing operations can include operations that are not in the neural network, e.g., line detection operations or other suitable linear or non-linear operations.

System 100 can cause the computed nodes 180 to generate an intermediate output 125 from the network layer 120. The intermediate output 125 includes two portions of data. The first portion of data includes a first set of upper-bit results generated by the input data 110 (also referred to as layer input 110 for neural network layers), and the second portion of data includes the layer input 110 or a second set of upper-bit results. Both the first portion of data and the second portion of data have the first data size. In some situations, the first set of upper-bit results are generated by the compute nodes 180 processing all bits of the layer input 110. In other situations, the first set of upper-bit results are generated by the compute nodes 180 processing a couple of highest bits of the layer input 110. The intermediate output 125 can be obtained using concatenation techniques, which are described in greater detail in connection with FIGS. 2, 3, and 4.

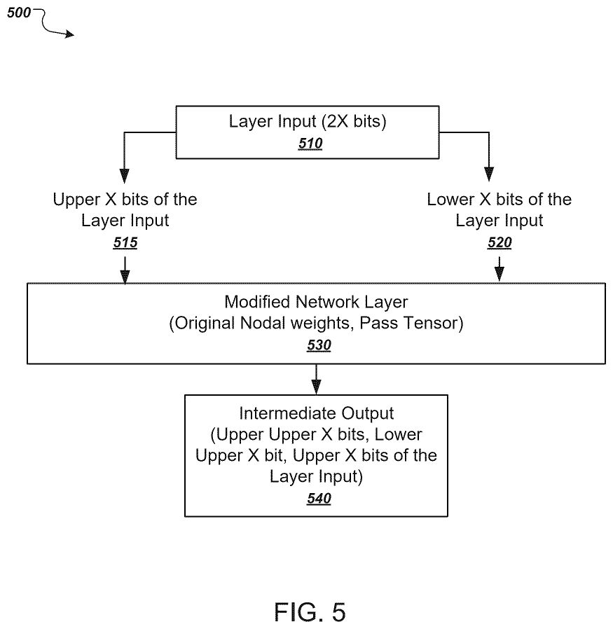

However, in situations where the compute nodes 180 or other hardware components do not support the memory bandwidth needed for concatenation techniques, where the efficiency and memory usage are concerned, or where the overhead time for data transfer in and out between the compute nodes and corresponding memory units is undesired, the described techniques can generate the intermediate output 125 using a modified network layer, The modified network layer includes the same nodal weights of the network layer 120 and one or more additional weights such that once the modified network layer processes the input data 110, the system 100 can obtain the intermediate output 125 directly without the need to perform concatenation operations. More details of generating intermediate output 125 without performing concatenation operations are described below in connection with FIG. 5.

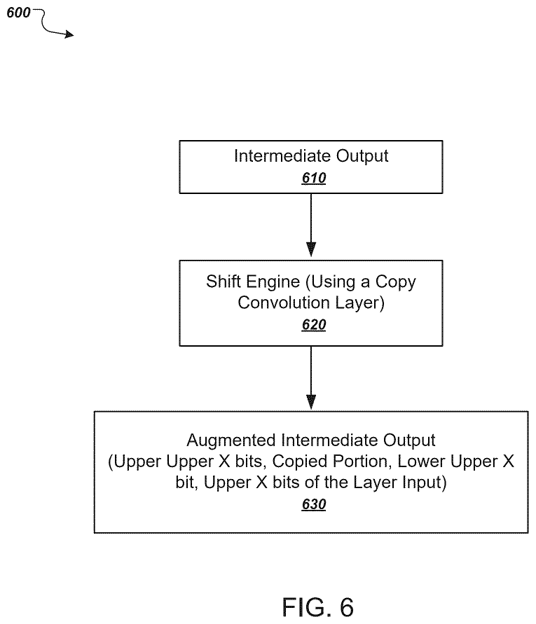

Optionally, system 100 can further process the intermediate output 125 using a shifting engine 130 to prevent overflow or underflow when shifting the digits for downstream operations. System 100 generally determines whether the number of digits to be shifted in the intermediate output 125 satisfies a criterion, e.g., the to-be-shifted number of digits being greater than a predetermined value (e.g., X digits, X being greater than or equal to one). In response to determining that the criterion is satisfied, system 100 processes the intermediate output 125 using shift engine 130 to prevent potential overflow or underflow during shifting. The shifting operations performed by the shift engine 130 include multiplying the intermediate output 125 with a quantization scale factor. More details of the operations performed by the shift engine 130 are described below in connection with FIG. 6.

System 100 can process the intermediate output 125 generated from the network layer 120 or the augmented intermediate output 135 generated from shift engine 130 using a new network layer 140 to generate the output data 150. The new network layer 140 is located immediately after the network layer 120. Note that the new network layer 140 is not originally included in the original neural network and is added in the neural network to preserve higher precision of the output that can be natively generated by one or more compute nodes 180. More specifically, the new network layer 140 includes the same nodal weights of the network layer and one or more additional nodal weights to account for higher precision. More details of the additional nodal weights and operations performed by the new network layer 140 are described below in connection with FIGS. 2, 3, and 4.

Output data 150 (or layer output for neural networks) is generally stored in a second data size greater than the first data size that is natively supported by the compute nodes 180. However, output data 150 can still have higher precision than those natively generated by one or more compute nodes 180, even for situations where the output data 150 is stored in the first data size since system 100 accounts for the contribution to the output data 150 due to lower bits of input data 110, as discussed above. The output data 150 can then be provided for other components for post-processing 160, as discussed above.

In addition, system 100 can be communicatively coupled with a memory unit 190. Memory unit 190 can be local or remote to system 100. In some cases, memory unit 190 is generally configured to store parameters set for system 100. For example, memory unit 190 can store a global variable to enable or disable precision enhancement techniques. In addition, memory unit 190 can further store the model parameters (e.g., nodal weights) for the neural network. Memory unit 190 can also provide these stored parameters to system 100 for performing neural network operations. In addition, the memory unit 190 can further store instructions for concatenation operations, parameters for the new network layer 140, and other suitable parameters or instructions. The memory unit 190 can further store data indicating the location of the decimal point, quantization scale factors, instructions associated with quantization or dequantization operations, and/or the other operations associated with shifting, rounding, and clipping operations. In some implementations, the memory unit 190 may optionally be configured to store and provide input data 110 to system 100, or temporarily store output data 150 (e.g., as a buffer), or both.

System 100 can be communicatively coupled to a server 195. Server 195 generally receives user requests for processing input data 110 using system 100. Server 195 can further receive the user input to enable or disable the precision enhancement function by changing the value of a global variable.

FIG. 2 illustrates an example operation flow 200 for generating a layer output 290 of 2X bits from a layer input 210 of X bits using the example precision enhancement system 100 of FIG. 1. The layer input 210 is equivalent to the input data 110 of FIG. 1 to a network layer in a neural network, and the layer output 290 is equivalent to the output data 150 of FIG. 1 generated from the network layer of the neural network. X represents a value greater than or equal to one. For example, X can be 8, 16, 24, or other suitable values.

System 100 causes one or more compute nodes to process layer input 210 through the original network layer 220 of a neural network. In this example operation flow 200, the original network layer 220 is equivalent to the network layer 120 of FIG. 1. The compute nodes are equivalent to compute nodes 180 of FIG. 1 that natively generate output with the first data size, e.g., X bits. The compute nodes are configured to compute an internal output for layer input 210 through the original network layer 220. Note that before storing or outputting the internal output to another component that is external to the compute nodes, the internal output can have a data size that is greater than the first data size. For example, the internal output can be temporarily stored in respective registers in sizes of 2X bits, 3X bits, 4X bits, or other suitable bits. However, due to the hardware limitation of the compute nodes, the data that is actually output from the original network layer 220 is rounded to be stored in the first data size (e.g., X bits). Thus, the data that is actually output from the original network layer 220 is equivalent to the upper X bits of the internal output. Since system 100 generates layer output 290 with higher precision using the upper X bits of the internal output, this data actually output from the original network layer 220 is also referred to as the upper X bits of the layer output 225.

System 100 then causes the concatenation engine 230 to generate an intermediate output 240 by concatenating the upper X bits of the layer output 225 with the layer input 210, Not that both the layer input 210 and the upper X bits of layer output 225 are stored using a data structure of X bits, and the intermediate output 240 is accordingly stored using data structures with a size of X bits. As an example, the intermediate output 240 can be arranged as (Upper X bits of the layer output, Layer input). One should note that another suitable arrangement for the intermediate output is viable as long as it is compatible with the overall computation operations.

System 100 can optionally process the intermediate output 240 using a shift engine 250 to shift digits of the values in the intermediate output and generate an augmented intermediate output 260. To cause the shift engine 250 to process the intermediate output 240, the system determines whether the number of digits to be shifted in the intermediate output 240 satisfies a predetermined criterion (e.g., a threshold number of digits to be shifted), and in response to determining that the predetermined criterion is satisfied, the system 100 causes the shift engine 250 to copy a portion of the intermediate output 240 to augment the intermediate output 240. Accordingly, the augmented intermediate output 260 includes (i) the intermediate output 240 and (ii) a copy of a portion of the intermediate output 240. For example, the copied portion can be the upper X bits of the layer output 225. More details of the copying operations of the shift engine and alternative operations using convolution are described below in greater detail in connection with FIG. 6.

System 100 processes the augmented intermediate output 260 using the new network layer 270. The new network layer 270 includes the original nodal weights of the original network layer 220 and one or more additional nodal weights that form an identity tensor. The identity tensor is also referred to as a pass tensor or a position tensor for two-dimensional computations. In general, the identity tensor has values of one in the diagonal positions and zero values in other positions. That being said, the identity tensor can further be scaled by a quantization scale factor for shifting digits of data such that different data are aligned by the decimal points for downstream operations such as multiplication or accumulation. The quantization scale factor ranges from zero to two to the power of X, i.e., [0, 2\hat{ }X].

System 100 can generate lower X bits of the layer output 275 directly from the new network layer 270. The lower X bits of the layer output 275 can then be combined with the upper X bits of the layer output 225 by adding operations 280 to generate a layer output 290 having a size of 2X bits.

To obtain the lower X bits of the layer output 275, system 100 first generates an internal result using the nodal weights of the original network layer 220 (which is the first portion of nodal weights of the new network layer 270) for the layer input 210. The internal result is equivalent to the internal output from the original network layer 220 before it is stored or output outside the original network layer 220. System 100 then subtracts the upper X bits of the layer output 275 from the internal result to obtain the lower X bits of the layer output 275. Because the new network layer 270 further includes additional nodal weights that form the identity tensor (or pass tensor or position tensor), system 100 can directly generate the lower X bits of the layer output 275 internally, without data transfer in and out between the compute nodes and external memory units.

One example formula for the operation flow 200 for a convolution layer of a neural network can be expressed as follows:
Upper X bits of the Layer Output=Conv(Layer Input);
Intermediate Output=Concat(Layer Input, Upper X bits of the Layer Output);
Lower X bits of the layer output=Conv(Layer Input)−Upper X bits of the Layer Output;
Layer Output=Lower X bits of the Layer Output+Upper X bits of the Layer Output. Formula (1)

Note that function Concat(*) represents concatenation operations, and Conv(*) represents convolution operations of the network layer to generate internal results. Note that in some implementations, system 100 can modify the original network layer 220 to replace the concatenation operations for higher efficiency, lower memory usage, and decreased overhead time for data transfer.

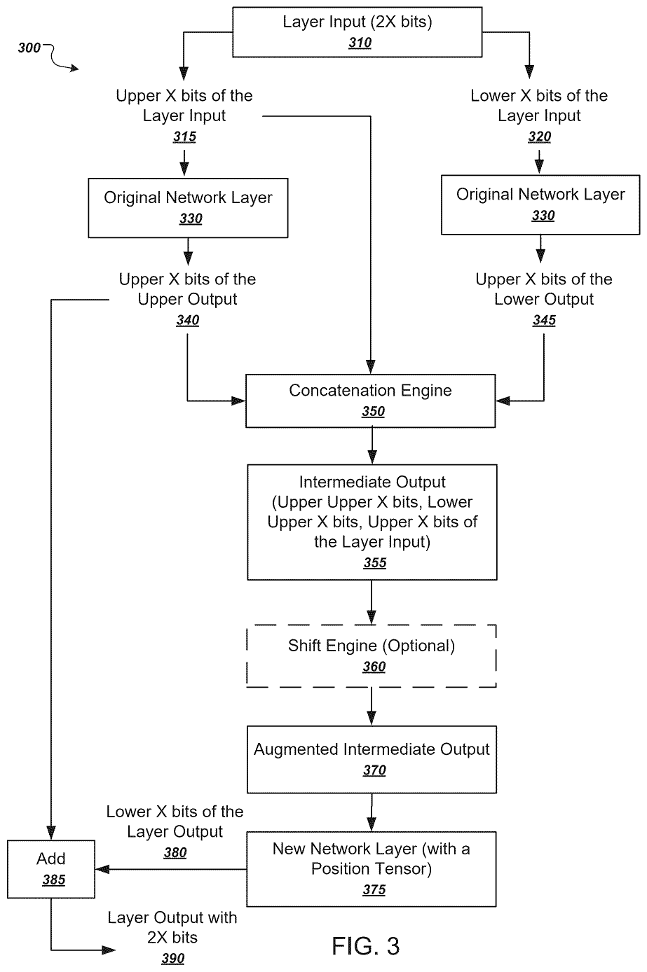

FIG. 3 illustrates an example operation flow 300 for generating a layer output 390 of 2X bits from a layer input 310 of 2X bits using the example precision enhancement system of FIG. 1. The layer input 310 is equivalent to the input data 110 of FIG. 1 to a network layer in a neural network, and the layer output 390 is equivalent to the output data 150 of FIG. 1 generated from the network layer of the neural network. X represents a value greater than or equal to one. For example, X can be 8, 16, 24, or other suitable values. As a more concrete example, the layer input 310 and the layer output 390 both have a size of 16 bits while the first data size natively supported by the one or more compute nodes is 8 bits.

Similar to the above description regarding FIG. 2, system 100 causes one or more compute nodes to process layer input 310 through the original network layer 330 of a neural network. In this example operation flow 300, the original network layer 330 is equivalent to the network layer 120 of FIG. 1. The compute nodes are equivalent to compute nodes 180 of FIG. 1 that natively generate output with the first data size, e.g., X bits.

System 100 can divide the layer input 310 into two portions. The first portion of the layer input 310 represents the upper X bits (also referred to as the upper X bits of the layer input 315). The second portion of layer input 310 represents the lower X bits (also referred to as the lower X bits of layer input 320).

System 100 processes the first portion through the original network layer 330 to generate a first output that is accessible by external components. The first output is also referred to as the upper X bits of the upper output 340 (or upper upper X bits output for simplicity). The upper X bits of the upper output 340 are of the same size that is natively supported by the compute nodes, and the stored X bits are the upper X bits of the internal result generated via the original network layer 330 from the upper X bits of the layer input 315.

Similarly, system 100 processes the second portion through the original network layer 330 to generate a second output that is accessible by external components. The second output is also referred to as the upper X bits of the lower output 345 (or lower upper X bits output for simplicity). The upper X bits of the lower output 345 are of the same size that is natively supported by the compute nodes, and the stored X bits are the upper X bits of the internal result generated via the original network layer 330 from the lower X bits of the layer input 320. Note that system 100 can concurrently process the above-noted two portions or according to a predetermined chronical order. More details of the precision loss due to the hardware limit of the compute nodes are described above.

System 100 then causes the concatenation engine 350 to generate an intermediate output 355 by concatenating the upper X bits of the upper output 340, the upper X bits of the lower output 345, and the upper X bits of the layer input 315. As an example, the intermediate output 355 can be arranged as (Upper Upper X bits, Lower Upper X bits, and Upper X bits of the Layer Input). One should note that another suitable arrangement for the intermediate output 355 is viable as long as it is compatible with the overall computation operations.

Similar to those described above, system 100 can optionally process the intermediate output 355 using a shift engine 360 to shift digits of the values in the intermediate output 355 to generate an augmented intermediate output 370. To cause the shift engine 350 to process the intermediate output 355, the system 100 determines whether the number of digits to be shifted in the intermediate output 355 satisfies a predetermined criterion (e.g., a threshold number of digits to be shifted), and in response to determining that the predetermined criterion is satisfied, the system 100 causes the shift engine 360 to copy a portion of the intermediate output 355 to augment the intermediate output 355. Accordingly, the augmented intermediate output 370 includes (i) the intermediate output 355 and (ii) a copy of a portion of the intermediate output 355. For example, the copied portion can be the upper upper X bits. More details of the copying operations of the shift engine and alternative operations using convolution are described below in greater detail in connection with FIG. 6.

System 100 processes the augmented intermediate output 370 using the new network layer 375. Similar to the new network layer 270 in FIG. 2, the new network layer 375 includes the original nodal weights of the original network layer 330 and one or more additional nodal weights that form an identity tensor. The identity tensor is also referred to as a pass tensor or a position tensor for two-dimensional computations. In general, the identity tensor has values of one in the diagonal positions and zero values in other positions. That being said, the identity tensor can further be scaled by a quantization scale factor for shifting digits of data such that different data are aligned by the decimal points for downstream operations such as multiplication or accumulation. The quantization scale factor ranges from zero to two to the power of X, i.e., [0, 2\hat{ }X].

System 100 can generate lower X bits of the layer output 380 directly from the new network layer 375. The lower X bits of the layer output 380 can then be combined with the upper X bits of the upper output 340 by adding operations 385 to generate a layer output 390 having a size of 2X bits.

To obtain the lower X bits of the layer output 380, system 100 first generates an internal result using the nodal weights of the original network layer 330 (which is the first portion of nodal weights of the new network layer 375) for processing the upper X bits of the layer input 315. The internal result is equivalent to the internal output from the original network layer 330 before it is stored or becomes accessible for external components. System 100 then subtracts the upper upper X bits from the internal result and adds back the lower upper X bits to obtain the lower X bits of the layer output 380. Because the new network layer 375 includes additional nodal weights that form the identity tensor (or pass tensor or position tensor), system 100 can directly generate the lower X bits of the layer output 380 internally, without data transfer in and out between the compute nodes and external memory units.

One example formula for the operation flow 300 for a convolution layer of a neural network can be expressed as follows:
Upper Upper X bits=Conv(Upper X bits of Layer Input);
Lower Upper X bits=Conv(Lower X bits of Layer Input);
Intermediate Output=Concat(Upper Upper X bits, Lower Upper X bits, Upper X bits of the Layer Output);
Lower X bits of the Layer Output=Conv (Upper X bits of the Layer Input)−Upper Upper X bits+Lower Upper X bits; and
Layer Output=Lower X bits of the Layer Output+Upper Upper X bits. Formula (2)
Note that function Concat(*) represents concatenation operations, and Conv(*) represents convolution operations of the network layer to generate internal results. Note that in some implementations, system 100 can modify the original network layer 330 to replace the concatenation operations for higher efficiency, lower memory usage, and decreased overhead time for data transfer.

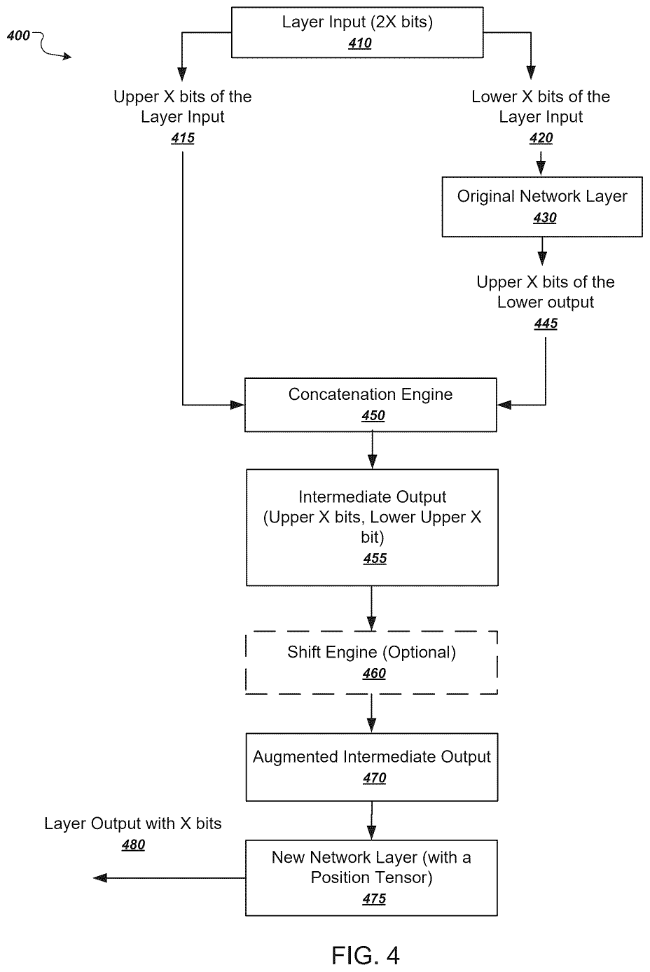

FIG. 4 illustrates an example operation flow 400 for generating a layer output 480 of X bits from a layer input 410 of 2X bits using the example precision enhancement system of FIG. 1. The layer input 410 is equivalent to the input data 110 of FIG. 1 to a network layer in a neural network, and the layer output 480 is equivalent to the output data 150 of FIG. 1 generated from the network layer of the neural network. X represents a value greater than or equal to one. For example, X can be 8, 16, 24, or other suitable values. As a more concrete example, the layer output 480 has a size of 8 bits, the same size as the first data size that is natively supported by the compute nodes, yet the layer output 480 still has a higher precision or accuracy that those directly generated by the compute nodes. This is because the system accounts for the contribution of lower bits of layer input 410 to the upper bits of the layer output 480, as described above. The layer input 410 has a size of 16 bits, which is double the size of the first data size.

Similar to the above description regarding FIG. 2, system 100 causes one or more compute nodes to process layer input 410 through the original network layer 430 of a neural network. In this example operation flow 300, the original network layer 430 is equivalent to the network layer 120 of FIG. 1. The compute nodes are equivalent to compute nodes 180 of FIG. 1 that natively generate output with the first data size, e.g., X bits.

System 100 can divide the layer input 410 into two portions. The first portion of the layer input 410 represents the upper X bits (also referred to as the upper X bits of the layer input 415). The second portion of the layer input 410 represents the lower X bits (also referred to as the lower X bits of the layer input 420).

As shown in FIG. 4, however, system 100 only processes the second portion through the original network layer 430 to generate an output that is accessible by external components. The output is also referred to as the upper X bits of the lower output 445 (or lower upper X bits output for simplicity). The upper X bits of the lower output 445 are of the same size that is natively supported by the compute nodes, and the stored X bits are the upper X bits of the internal result generated via the original network layer 430 from the lower X bits of the layer input 420. More details of the precision loss due to the hardware limit of the compute nodes are described above.

System 100 then causes the concatenation engine 450 to generate an intermediate output 455 by concatenating the upper X bits of the lower output 445 and the upper X bits of the layer input 415. As an example, the intermediate output 455 can be arranged as (Upper X bits of Layer Input, Lower Upper X bits). One should note that another suitable arrangement for the intermediate output 455 is viable as long as it is compatible with the overall computation operations.

Similar to those described above, system 100 can optionally process the intermediate output 455 using a shift engine 460 to shift digits of the values in the intermediate output 455 to generate an augmented intermediate output 470. To cause the shift engine 450 to process the intermediate output 455, the system 100 determines whether the number of digits to be shifted in the intermediate output 455 satisfies a predetermined criterion (e.g., a threshold number of digits to be shifted), and in response to determining that the predetermined criterion is satisfied, the system 100 causes the shift engine 460 to copy a portion of the intermediate output 455 to augment the intermediate output 455. Accordingly, the augmented intermediate output 470 includes (i) the intermediate output 455 and (ii) a copy of a portion of the intermediate output 455. For example, the copied portion can be the upper X bits of the layer input. More details of the copying operations of the shift engine and alternative operations using convolution are described below in greater detail in connection with FIG. 6.

System 100 processes the augmented intermediate output 470 using the new network layer 475. Similar to the new network layer 270 in FIG. 2, the new network layer 475 includes the original nodal weights of the original network layer 430 and one or more additional nodal weights that form an identity tensor. The identity tensor is also referred to as a pass tensor or a position tensor for two-dimensional computations. In general, the identity tensor has values of one in the diagonal positions and zero values in other positions. That being said, the identity tensor can further be scaled by a quantization scale factor for shifting digits of data such that different data are aligned by the decimal points for downstream operations such as multiplication or accumulation. The quantization scale factor ranges from zero to two to the power of X, i.e., [0, 2\hat{ }X].

System 100 can generate the layer output 480 of a size of X bits directly from the new network layer 475. To obtain the layer output 480, system 100 first generates an internal result using the nodal weights of the original network layer 430 (which is the first portion of nodal weights of the new network layer 475) for processing the upper X bits of the layer input 415. The internal result is equivalent to the internal output from the original network layer 430 before it is stored or becomes accessible for external components. System 100 then subtracts the lower upper X bits from the internal result to obtain the layer output 480. Because the new network layer 475 includes additional nodal weights that form the identity tensor (or pass tensor or position tensor), system 100 can directly generate the layer output 480 internally, without data transfer in and out between the compute nodes and external memory units.

One example formula for the operation flow 400 for a convolution layer of a neural network can be expressed as follows:
Lower Upper X bits=Conv(Lower X bits of Layer Input);
Intermediate Output=Concat(Upper X bits of the Layer Output, Lower Upper X bits); and
Layer Output=Conv (Upper X bits of the Layer Input)+Lower Upper X bits. Formula (3)

Note that function Concat(*) represents concatenation operations, and Conv(*) represents convolution operations of the network layer to generate internal results. Note that in some implementations, system 100 can modify the original network layer 430 to replace the concatenation operations for higher efficiency, lower memory usage, and decreased overhead time for data transfer.

FIG. 5 illustrates an example operation flow 500 for generating an intermediate output 540 using a modified network layer.

Instead of using concatenation techniques to generate an intermediate output as described above, system 100 can modify the structure and nodal weights of the network layer of a neural network to generate the intermediate output inside the compute nodes. This way, the system (and the compute nodes) does not need to communicate data when generating the intermediate result, which reduces the overhead time (or compute node idle time) for data transfer in and out between the compute nodes and external memories, e.g., one or more DRAMs.

The modified network layer can include the original nodal weights of the original network layer, and one or more additional nodal weights. The system can augment the size in one or more dimensions of the original network layer and add corresponding additional nodal weights to the augmented region of the network layer. The one or more additional nodal weights can form an identity tensor (or an identity matrix in two-dimensional data structures). The identity tensor has zero values in off-diagonal positions and values in the in-diagonal positions. Note that the identity tensor can also scaled by a quantization scale factor for shifting digits (more details of shifting are described below in connection with FIG. 6). The identity tensor is also referred to as pass tensor or position tensor.

As shown in FIG. 5, system 100 can split the layer input 520 into two portions, e.g., the upper X bits of the layer input 515 and the lower X bits of the layer input 520. Similar to the above description regarding FIG. 3, system 100 can process the upper X bits of the layer Input 515 and the lower X bits of the layer input 520 through the modified network layer 530, respectively. Note that system 100 can concurrently process the two portions or according to a predetermined chronical order.

The modified network layer can be arranged such that a first set of channels stores the original nodal weights of the original network layer, and a second set of channels stores the identity tensor, as shown in FIG. 5. This way, system 100 can directly generate the intermediate output 540 using internal operations of the modified network layer 530, without the need to read and write intermediate results back and forth between the compute nodes and external memories.

FIG. 6 illustrates an example operation flow 600 for generating an augmented intermediate output 630 using a copy convolution layer 620.

As described above, the intermediate output is processed by a shift engine after the system determines that the total number of digits to be shifted in the intermediate output exceeds a threshold shift value. For example, for the compute nodes being an array of MAC units, the system can only add or subtract values when their respective decimal points are aligned. To align decimal points, the system needs to determine whether to shift one or more digits of a stored numerical value and determine the number of digits to be shifted using a quantization scale factor. The number of digits that can be shifted is generally smaller than a threshold shift value.

The compute nodes generally dictate the threshold shift value. For example, for a compute node with a precision limit of X digits, the threshold shift value can also be X digits. If the system determines that the total number of digits to be shifted in the intermediate output is greater than X bits, the system then uses the shift engine to “transcend” the threshold shift value by copying a portion of the intermediate output. Copying techniques are viable for shifting purposes because of the binary nature of data structures in computer software. More specifically, the system can shift X+1 digits by simply subtracting or adding two times the X-digit values. For example, if the system determines to shift 9 digits using compute nodes having a threshold shift value of 8 digits, the system can copy the 8-digit data twice and subtract the 8-bit data and the copied data. As another example, if the system determines to shift 10 digits using the same compute nodes, the system can copy the 8-digit data three times and subtract the 8-bit data and the three copied data. One example algorithm for determining whether to use the shift engine is presented below.

Assume that the quantization scale inside the compute nodes is determined based on the multiplication of the quantization scale for the layer input and the quantization scale for the nodal weights of the network layer, i.e., Quant_scale_in_conv_accumulator=input_quant_scale *weight_quant_scale. Then, the quantization scale for layer output can be determined based on the quantization scale inside the compute nodes and an adjusting quantization scale. The adjusting quantization scale is determined based on statistical observations from calibration data.

To compute the lower X bits of the layer output, the system needs to ensure the quantization scale for layer output is manipulated to match the quantization scale inside the compute nodes. Thus, the shifting digits (or shifting quantization scale) are determined by a division operation between these two quantization scales.

The system first compares the shifting quantization scale with a range between [0, 2\hat{ }X]. In response to determining that the shifting quantization scale falls within that range, the system does not need to use the shift engine to copy a portion of corresponding data. However, if the system determines that the shifting quantization scale is greater than 2\hat{ }X, the shift engine copies a portion of the corresponding data for (shifting quantization scale/(2\hat{ }X)−1) times. Moreover, in response to determining that the shifting quantization scale is less than one, the shift engine does not copy data since adjusting the quantization scale would result in the loss of the least significant bits. The system thus does not adjust the quantization scale and simply sets the shifting quantization scale to be one.

As a more concrete example, for a compute node that natively outputs data in 8 bits, assuming the layer input quantization scale is 2\hat{ }5, the nodal weight quantization scale is 2\hat{ }5, and the adjust quantization scale is 2\hat{ }(−9), the quantization scale inside the compute node is determined to be 2\hat{ }10. The shifting quantization scale is 2\hat{ }9, which is greater than 2\hat{ }8. The system accordingly copies a portion of the relevant data, and the number of copies is 1, which is calculated by (2\hat{ }9/2\hat{ }8−1) as described above. The position matrix is scaled by 2\hat{ }8.

As shown in FIG. 6, instead of copying a portion of intermediate output 620 after the intermediate output 620 is output from the compute nodes to generate the augmented intermediate output 630 (as described above in connection with FIGS. 2, 3, and 4), the system can adopt a copy convolution layer for use by the shift engine 620. The copy convolution layer is a new network layer that is not originally included in the neural network. The copy convolution layer can include one or more identity tensors (or position tensors or pass tensors, as described above) to copy a portion of the input, such that the system can subtract one or more copies of that portion of data to shift the target number of digits of the intermediate output, when the target number of digits to be shifted exceeds the threshold shift value.

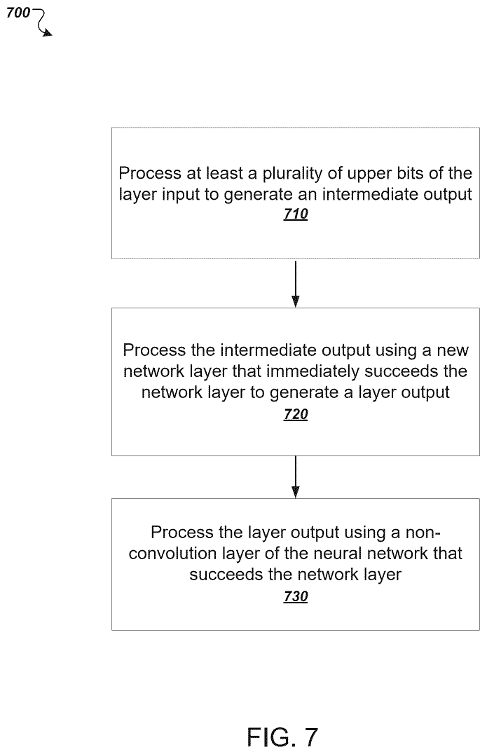

FIG. 7 is a flow diagram of an example process 700 for processing a layer input to generate a layer output. For convenience, the example process 700 is described as being performed by a system of one or more computers located in one or more locations. For example, the precision enhancement system 100 of FIG. 1, when appropriately programmed, can perform the process 700.

The system is configured to process operations of a neural network using one or more compute nodes to generate output with enhanced precision even though the one or more compute nodes can natively generate output having a lower precision. As described above, although the term “precision” generally relates to the data size by which numerical data is stored, data stored using the same size (or the same number of bits) as the other data can still have higher precision if the system accounts for the contribution from lower bits when performing the computation operations.

As described above, due to hardware limits, at least one or more compute nodes natively generate output with a first data size. The first data size can be X bits, where X is a positive integer, e.g., 8, 16, 24, etc. The system can enhance the output precision by breaking through the hardware limits by implementing the described techniques. For example, the system can generate a layer output of 2X bits for a layer input of X bits. As another example, the system can generate a layer output of 2X bits for a layer input of 2X bits. As a further example, the system can generate a layer output of X bits for a layer input of 2X bits, yet the layer output still has a higher precision than that could have been generated directly by the one or more compute nodes.

The system performs computation operations represented by a machine learning model. For example, the machine learning model can be a neural network having one or more layers, each layer having one or more nodes with respective nodal weights. The system can process a layer input through the neural network to generate a layer output with enhanced precision higher than that natively supported by the one or more compute nodes. In some implementations, the network layer is the last convolution layer of the neural network.

In addition, one or more compute nodes can include one or more accumulators, one or more multiplier-accumulator (MAC) units, or other suitable nodes. The one or more compute nodes can also be arranged according to a predetermined fashion, e.g., an array of MAC units. In some implementations, the one or more nodes can be included or constitute one or more CPUs, GPUs, or other suitable processing units.

The system processes at least a plurality of upper bits of the layer input via the network layer to generate an intermediate output (710). As described above, the intermediate output includes a first portion and a second portion. The first portion includes a first set of upper-bit results generated from the plurality of upper bits of the layer input, where the first set of upper bit results has the first data size. the second portion includes the layer input or a second set of upper-bit results having the first data size.

As an example, when processing the layer input, the system can process in fact all bits of the layer input to generate the first set of upper-bit results having the first data size. In some implementations where the layer input having a data size greater than the limit natively supported by the compute nodes, the system can process only the highest X bits of the layer input to generate the first set of upper-bit results having the first data size. For example, for compute nodes having a limit of X bits and the layer input having a size of 2X bits, the system processes the upper X bits of the 2X bits of the layer input and generates a layer output of 2X bits (or of X bits) with a precision higher than that directly generated by the compute nods.

In addition, the system can generate the intermediate output by concatenating the first set of upper-bit results with the layer input. In some implementation, the system can generate the intermediate output by concatenating the first set of upper-bit results with the second set of upper-bit results having the first data size. More details are described above in connection with FIGS. 2, 3, and 4.

Instead of performing concatenation operations to generate the intermediate output, the system can modify the weights of the original network layer to include one or more additional weights. The system accordingly processes at least the plurality of upper bits of the layer input using the modified version of the network layer. The modified version of the network layer can include the same nodal weights of the network layer and one or more additional nodal weights that form an identity tensor. The identity tensor serves to pass down relevant data and allows the system to directly generate the intermediate output without the need to perform the concatenation operations, further improving the efficiency and reducing the memory bandwidth usage.

The system processes the intermediate output using a new network layer that immediately succeeds the network layer to generate a layer output. (720). As described above, the new network layer can include the same nodal weights of the network layer and one or more additional nodal weights. The new network layer is not natively included in the neural network. The one or more additional nodal weights form an identity tensor, as described above.

The layer output has the first data size natively supported by the compute nodes. Alternatively, the layer output has a second data size that is greater than the first data size. In general, the layer output has a higher precision than an output that is directly generated by processing the layer input via the network layer using the one or more nodes.

The system further processes the layer output using a non-convolution layer of the neural network that succeeds the network layer (730). For example, the non-convolution layer immediately succeeding the last convolution layer can be a softmax layer, a fully connected layer, or other suitable layers. In some implementations, the layer output is transferred to be further processed by downstream or post-processing components. One example post-processing operation can include line detection for image processing.

In some implementations, the system processes the intermediate output to generate an augmented intermediate output before processing the intermediate output via the new network layer. The augmented intermediate output generally includes all data of the intermediate output and, additionally, a copy of a portion of the intermediate output.

The system copies the portion of the intermediate output and passes it down to the new network layer for shifting purposes. More specifically, the system copies the portion of the intermediate output and concatenates the copied portion into a predetermined location of the intermediate output, for example, append the copied portion immediately after the data that is copied in the intermediate output.

In some implementations, instead of directly copying the portion of data, the system can process the intermediate output using a copy convolution layer. The copy convolution layer can include nodal weights that form an identity tensor, where the identity tensor can be used to copy and pas down the copied portion for downstream processing, as described above.

To determine whether to generate the augmented intermediate output, the system first determines a number of shift digits to shift the intermediate output based on a quantization scale factor for the intermediate output. If the number of shift digits exceeds a predetermined threshold shift value, the system determines to process the intermediate output to generate the augmented intermediate output using direct copy operations or the copy convolution layer, as described above.

After the augmented intermediate output is generated, the system processes the augmented intermediate output using the new network layer, as described above, to generate the layer output.

In some implementations, the system can include a global variable to allow the user to disable or enable the precision enhancement function by toggling a parameter value. For example, a user can set the global variable to a first value to cause the system (or the compute nodes) to perform the precision enhancement operations described above. The user can further set the global variable to a second value to cause the system (or the compute nodes) to stop performing the precision enhancement operations described above.

When the above-noted instructions are deployed on a host or other suitable hardware, the above-described precision enhancement operations can be set to be disabled by default, and a user can activate the function by setting the global variable to the second value.

In some implementations, the system can further include a second global variable to allow the user to choose whether to use one or more nodes on a CPU, a GPU, or other suitable processing units to perform the above-described precision enhancement operations.

The term “machine learning model” throughout the specification stands for any suitable model used for machine learning. As an example, the machine learning model can include one or more neural networks trained for performing different inference tasks. Examples of neural networks and tasks performed by neural networks are described in greater detail at the end of the specification. For simplicity, the term “machine learning models” is sometimes referred to as “neural network models” or “deep neural networks” in the following specification.

Depending on the task, a neural network can be configured, i.e., through training, to receive any kind of digital data input and to generate any kind of score, classification, or regression output based on the input.

In some cases, the neural network is a neural network that is configured to perform an image processing task, i.e., receive an input image and process the input image to generate a network output for the input image. In this specification, processing an input image refers to processing the intensity values of the pixels of the image using a neural network. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual image processing or computer vision tasks, i.e., by generating the output for the multiple different individual image processing tasks in parallel by processing a single input image.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language specification, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it, software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method for performing operations of a neural network, the method comprising: processing a layer input to a network layer of a neural network and one or more nodal weights of the network layer using one or more compute nodes, wherein at least one of the one or more compute nodes natively generates output having a first data size, wherein the processing comprises: processing at least a plurality of upper bits of the layer input to generate an intermediate output, wherein the intermediate output comprises a first portion and a second portion, wherein the first portion comprises a first set of upper-bit results generated from the plurality of upper bits of the layer input and the first set of upper bit results has the first data size, and wherein the second portion comprises the layer input or a second set of upper-bit results having the first data size; and processing the intermediate output using a new network layer that immediately succeeds the network layer to generate a layer output, wherein the new network layer comprises the same nodal weights of the network layer and one or more additional nodal weights, and wherein the layer output has the first data size or a second data size greater than the first data size, the layer output having a higher precision than an output directly generated by processing the layer input via the network layer using the one or more nodes.

Embodiment 2 is the method of Embodiment 1, wherein the network layer is the last convolution layer of the neural network, wherein the new network layer is not natively included in the neural network, and wherein the one or more additional nodal weights form an identity tensor.

Embodiment 3 is the method of Embodiment 1 or 2, comprising processing the layer output using a non-convolution layer of the neural network that succeeds the network layer.

Embodiment 4 is the method of any one of Embodiments 1-3, wherein processing at least the plurality of upper bits of the layer input via the network layer using the one or more compute nodes comprises processing all bits of the layer input to generate the first set of upper-bit results having the first data size.

Embodiment 5 is the method of any one of Embodiments 1-4, wherein processing at least the plurality of upper bits of the layer input via the network layer using the one or more compute nodes comprises: processing the highest X bits of the layer input to generate the first set of upper-bit results having the first data size, wherein the first data size has a size of X bits and the layer input has a size of 2X bits, X being greater than or equal to one.

Embodiment 6 is the method of any one of Embodiments 1-5, wherein the second set of upper-bit results is generated by a set of lower bits of the layer input, and wherein the intermediate output is generated by concatenating the first set of upper-bit results with the layer input or the second set of upper-bit results having the first data size.

Embodiment 7 is the method of any one of Embodiments 1-6, wherein the intermediate output is generated by operations comprising: processing at least the plurality of upper bits of the layer input using a modified version of the network layer, wherein the modified version of the network layer comprises the same nodal weights of the network layer and one or more additional nodal weights that form an identity tensor.

Embodiment 8 is the method of any one of Embodiments 1-7, comprising: before processing the intermediate output using the new network layer, processing the intermediate output to generate an augmented intermediate output, wherein the augmented intermediate output comprises (i) the intermediate output and (ii) a copy of a portion of the intermediate output; and processing the augmented intermediate output using the new network layer.

Embodiment 9 is the method of Embodiment 8, wherein processing the intermediate output to generate an augmented intermediate output comprises: copying the portion of the intermediate output and concatenating the copied portion into the intermediate output.

Embodiment 10 is the method of Embodiment 8 or 9, wherein processing the intermediate output to generate an augmented intermediate output comprises processing the intermediate output using a copy convolution layer, wherein the copy convolution layer comprises nodal weights that form an identity tensor.

Embodiment 11 is the method of any one of Embodiments 8-10, comprising: determining a number of shift digits based on a quantization scale factor for the intermediate output; and in response to determining that the number of shift digits is greater than a pre-determined value, processing the intermediate output to generate the augmented intermediate output.

Embodiment 12 is the method of any one of Embodiments 1-11, wherein the first data size comprises X bits, wherein the layer input comprises X bits, and wherein the layer output has the second data size comprising 2X bits, X being greater than or equal to one.

Embodiment 13 is the method of any one of Embodiments 1-12, wherein the first data size comprises X bits, wherein the layer input comprises 2X bits, and wherein the layer output has the second data size comprising 2X bits, X being greater than or equal to one.

Embodiment 14 is the method of any one of Embodiments 1-13, wherein the first data size comprises X bits, wherein the layer input comprises 2X bits, and wherein the layer output has the first data size comprising X bits, X being greater than or equal to one.

Embodiment 15 is the method of any one of Embodiments 1-14, wherein the one or more compute nodes comprise an array of multiplier-accumulator (MAC) units.

Embodiment 16 is method of any one of Embodiments 1-15, wherein the one or more compute nodes comprise a central processing unit.

Embodiment 17 is the method of any one of Embodiments 1-16, comprising setting a global parameter to a first value to cause one or more computers to perform operations of the method.

Embodiment 18 is the method of any one of Embodiments 1-17, comprising setting a global parameter to a second value to cause one or more computers to stop performing operations of the method.

Embodiment 19 is a system comprising one or more computers and one or more storage devices storing instructions that when executed by one or more computers cause the one or more computers to perform respective operations, the operations comprising the method of any one of Embodiments 1-18.

Embodiment 20 is one or more computer-readable storage media storing instructions that when executed by one or more computers cause the one or more computers to perform respective operations, the respective operations comprising the method of any one of Embodiments 1-18.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A method for performing operations of a neural network, the method comprising:
processing a layer input to a network layer of a neural network and one or more nodal weights of the network layer using one or more compute nodes, wherein at least one of the one or more compute nodes natively generates output having a first data size, wherein the processing comprises:
processing at least a plurality of upper bits of the layer input to generate an intermediate output, wherein the intermediate output comprises a first portion and a second portion, wherein the first portion comprises a first set of upper-bit results generated from the plurality of upper bits of the layer input and the first set of upper bit results has the first data size, and wherein the second portion comprises the layer input or a second set of upper-bit results having the first data size; and
processing the intermediate output using a new network layer that immediately succeeds the network layer to generate a layer output, wherein the new network layer comprises the same nodal weights of the network layer and one or more additional nodal weights, and wherein the layer output has the first data size or a second data size greater than the first data size, the layer output having a higher precision than an output directly generated by processing the layer input via the network layer using the one or more nodes.

2. The method of claim 1, wherein the network layer is the last convolution layer of the neural network, wherein the new network layer is not natively included in the neural network, and wherein the one or more additional nodal weights form an identity tensor.

3. The method of claim 1, comprising:
processing the layer output using a non-convolution layer of the neural network that succeeds the network layer.

4. The method of claim 1, wherein processing at least the plurality of upper bits of the layer input via the network layer using the one or more compute nodes comprises:
processing all bits of the layer input to generate the first set of upper-bit results having the first data size.

5. The method of claim 1, wherein processing at least the plurality of upper bits of the layer input via the network layer using the one or more compute nodes comprises:
processing the highest X bits of the layer input to generate the first set of upper-bit results having the first data size, wherein the first data size has a size of X bits and the layer input has a size of 2X bits, X being greater than or equal to one.

6. The method of claim 1, wherein the second set of upper-bit results is generated by a set of lower bits of the layer input, and wherein the intermediate output is generated by concatenating the first set of upper-bit results with the layer input or the second set of upper-bit results having the first data size.

7. The method of claim 1, wherein the intermediate output is generated by operations comprising:
processing at least the plurality of upper bits of the layer input using a modified version of the network layer, wherein the modified version of the network layer comprises the same nodal weights of the network layer and one or more additional nodal weights that form an identity tensor.

8. The method of claim 1, comprising:
before processing the intermediate output using the new network layer, processing the intermediate output to generate an augmented intermediate output, wherein the augmented intermediate output comprises (i) the intermediate output and (ii) a copy of a portion of the intermediate output; and
processing the augmented intermediate output using the new network layer.

9. The method of claim 8, wherein processing the intermediate output to generate an augmented intermediate output comprises: copying the portion of the intermediate output and concatenating the copied portion into the intermediate output.

10. The method of claim 8, wherein processing the intermediate output to generate an augmented intermediate output comprises processing the intermediate output using a copy convolution layer, wherein the copy convolution layer comprises nodal weights that form an identity tensor.

11. The method of claim 8, comprising:
determining a number of shift digits based on a quantization scale factor for the intermediate output; and
in response to determining that the number of shift digits is greater than a pre-determined value, processing the intermediate output to generate the augmented intermediate output.

12. The method of claim 1, wherein the first data size comprises X bits, wherein the layer input comprises X bits, and wherein the layer output has the second data size comprising 2X bits, X being greater than or equal to one.

13. The method of claim 1, wherein the first data size comprises X bits, wherein the layer input comprises 2X bits, and wherein the layer output has the second data size comprising 2X bits, X being greater than or equal to one.

14. The method of claim 1, wherein the first data size comprises X bits, wherein the layer input comprises 2X bits, and wherein the layer output has the first data size comprising X bits, X being greater than or equal to one.

15. The method of claim 1, wherein the one or more compute nodes comprise an array of multiplier-accumulator (MAC) units.

16. The method of claim 1, wherein the one or more compute nodes comprise a central processing unit.

17. The method of claim 1 comprising setting a global parameter to a first value to cause one or more computers to perform operations of the method.

18. The method of claim 1, comprising setting a global parameter to a second value to cause one or more computers to stop performing operations of the method.

19. A system comprising one or more computers and one or more storage devices storing instructions that, when executed by one or more computers, cause the one or more computers to perform respective operations, the operations comprising:
processing a layer input to a network layer of a neural network and one or more nodal weights of the network layer using one or more compute nodes, wherein at least one of the one or more compute nodes natively generates output having a first data size, wherein the processing comprises:
processing at least a plurality of upper bits of the layer input to generate an intermediate output, wherein the intermediate output comprises a first portion and a second portion, wherein the first portion comprises a first set of upper-bit results generated from the plurality of upper bits of the layer input and the first set of upper bit results has the first data size, and wherein the second portion comprises the layer input or a second set of upper-bit results having the first data size; and
processing the intermediate output using a new network layer that immediately succeeds the network layer to generate a layer output, wherein the new network layer comprises the same nodal weights of the network layer and one or more additional nodal weights, and wherein the layer output has the first data size or a second data size greater than the first data size, the layer output having a higher precision than an output directly generated by processing the layer input via the network layer using the one or more nodes.

20. One or more computer-readable storage media storing instructions that, when executed by one or more computers, cause the one or more computers to perform respective operations, the respective operations comprising:
processing a layer input to a network layer of a neural network and one or more nodal weights of the network layer using one or more compute nodes, wherein at least one of the one or more compute nodes natively generates output having a first data size, wherein the processing comprises:
processing at least a plurality of upper bits of the layer input to generate an intermediate output, wherein the intermediate output comprises a first portion and a second portion, wherein the first portion comprises a first set of upper-bit results generated from the plurality of upper bits of the layer input and the first set of upper bit results has the first data size, and wherein the second portion comprises the layer input or a second set of upper-bit results having the first data size; and
processing the intermediate output using a new network layer that immediately succeeds the network layer to generate a layer output, wherein the new network layer comprises the same nodal weights of the network layer and one or more additional nodal weights, and wherein the layer output has the first data size or a second data size greater than the first data size, the layer output having a higher precision than an output directly generated by processing the layer input via the network layer using the one or more nodes.
